(19) United States
(12) Patent Application Publication
(10) Pub. No.: US 2026/0134532 A1
(43) Pub. Date: May 14, 2026

(54) INSPECTION APPARATUS, CONTROL METHOD OF INSPECTION APPARATUS, AND NON-TRANSITORY COMPUTER-READABLE STORAGE MEDIUM

(71) Applicant: CANON KABUSHIKI KAISHA, Tokyo (JP)

(72) Inventor: Ryo KAZUMI, Kanagawa (JP)

(21) Appl. No.: 19/378,422

(22) Filed: Nov. 4, 2025

(30) Foreign Application Priority Data
Nov. 14, 2024 (JP) 2024-199203

(51) Int. Cl. G06T 7/00; G06T 7/13

(52) U.S. Cl. CPC G06T 7/0008; G06T 7/001; G06T 7/13; G06T 2207/30144

(57) ABSTRACT

An inspection apparatus that acquires an image including an inspection target sheet; sets a reference point that is a reference of a corner crease of the inspection target sheet; and determines presence/absence of the corner crease of the inspection target sheet based on the reference point and an outline of the inspection target sheet in the image.

### BACKGROUND

### Field of the Technology

The present disclosure relates to an inspection apparatus, a control method of the inspection apparatus, and a non-transitory computer-readable storage medium.

### DESCRIPTION OF THE RELATED ART

There is recently known a printing system in which a print sheet printed by a printing apparatus is inspected in the printing apparatus or an inspection apparatus. The inspection apparatus captures an image of a conveyed print sheet and analyzes the captured image, thereby determining whether the print sheet is normal or not. That is, the inspection apparatus can detect, for example, a deviation between a pattern print position and a sheet (sheet print position deviation) or a print abnormality, a corner crease of a print sheet, or the like. Concerning the corner crease of a print sheet, in Japanese Patent Laid-Open No. 2020-33145, it is described that a technique of determining a corner crease based on the angle of a sheet edge. In addition, in Japanese Patent Laid-Open No. 2020-45212, it describes a technique in which if a corner crease is in a cut region, it is determined that the print sheet is normal. If it is determined that a print sheet is abnormal, the abnormal print sheet is discharged to a discharge destination different from that for a normal print sheet. This can prevent the abnormal print sheet from being mixed among normal print sheets and allows an operator to discard the abnormal print sheet.

In the technique of Japanese Patent Laid-Open No. 2020-33145, even if the crease amount is small, and a user wants to use the sheet, it may be determined as abnormal and discarded. Hence, such corner crease determination is not in conformity with the user's intention. Also, in the technique of Japanese Patent Laid-Open No. 2020-45212, when printing a patch in the cut region, the corner crease and the patch overlap. This may affect the stacking property in a post-processing apparatus or linearity at the time of cutting. Hence, such corner crease determination does not conform to a print job or post-processing.

### SUMMARY

The present disclosure enables realization of a new mechanism capable of implementing inspection of a print sheet conforming to the user's intention, a print job, or post-processing.

One aspect of the present disclosure provides an inspection apparatus comprising: one or more memory devices that store a set of instructions; and one or more processors that execute the set of instructions to: acquire an image including an inspection target sheet; set a reference point that is a reference of a corner crease of the inspection target sheet; and determine presence/absence of the corner crease of the inspection target sheet based on the reference point and an outline of the inspection target sheet in the image.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view of a printing system according to an embodiment;

FIG. 2 is a block diagram of the printing system according to the embodiment;

FIG. 3 is a schematic view of an image forming apparatus according to the embodiment;

FIG. 4 is a flowchart of processing according to the embodiment;

FIG. 5 is a flowchart of processing according to the embodiment;

FIG. 6 is a flowchart of processing according to the embodiment;

FIG. 7 is a flowchart of processing according to the embodiment;

FIG. 8 is a flowchart of processing according to the embodiment;

FIG. 9 is a flowchart of processing according to the embodiment;

FIG. 10 is a flowchart of processing according to the embodiment;

FIG. 11 is a flowchart of processing according to the embodiment;

FIG. 12 is a flowchart of processing according to the embodiment;

FIGS. 13A and 13B are views showing a display screen according to the embodiment;

FIG. 14 is a view showing a display screen according to the embodiment;

FIG. 15 is an explanatory view of calculation of a corner crease according to the embodiment;

FIG. 16 is an explanatory view of calculation of an edge according to the embodiment;

FIGS. 17A to 17C are explanatory views of the definition of a corner crease amount according to the embodiment;

FIGS. 18A and 18B are explanatory views of a corner crease search algorithm according to the embodiment;

FIG. 19 is a flowchart of processing according to the embodiment;

FIG. 20 is a view showing a display screen according to the embodiment;

FIG. 21 is a view showing a display screen according to the embodiment;

FIG. 22 is a flowchart of processing according to the embodiment; and

FIG. 23 is an explanatory view of calculation of a temporary vertex according to the embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

In this specification, a term "image forming apparatus" broadly includes apparatuses that form (print) an image on a print material (print medium), such as a single-function printer, a copying machine, a multifunction printer, and a commercial printing machine. In addition, the image forming apparatus may be a system (image forming system) formed by connecting an image forming apparatus main body that forms an image on a print material and apparatuses such as a sheet processing apparatus and a sheet feed apparatus.

In the following explanation, an external controller is also called an image processing controller, a digital front end (DFE), or a print server. The image forming apparatus is also called a multifunction printer or a multi function peripheral (MFP).

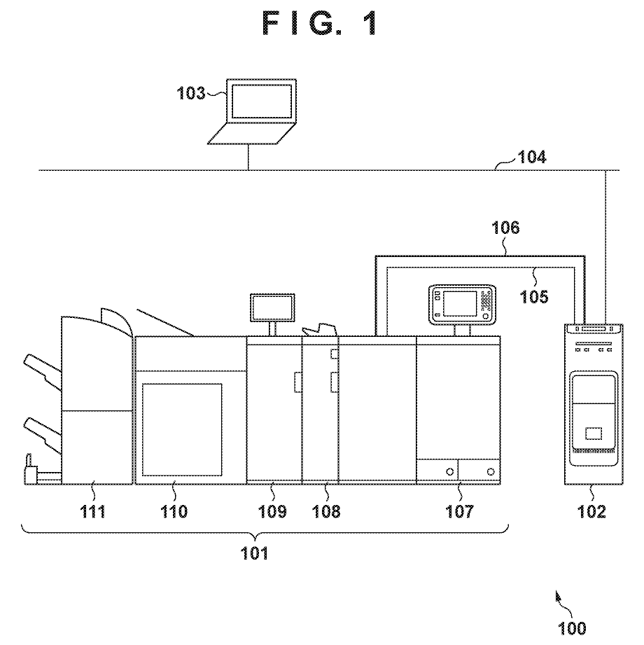

The overall hardware configuration of an image forming system 100 will be described with reference to FIG. 1. The image forming system 100 is configured to include an image forming apparatus 101 and an external controller 102. The image forming apparatus 101 and the external controller 102 are communicably connected via an internal LAN 105 and a video cable 106. Note that the video cable 106 may not have the configuration, and its function may be provided by the internal LAN 105. The external controller 102 is communicably connected to a client PC 103 via an external LAN 104, and a print instruction is sent from the client PC 103 to the external controller 102.

In the client PC 103, a printer driver having a function of converting print data into a page description language processible by the external controller 102 is installed. A user who performs printing can input a print instruction from various kinds of applications via the printer driver. The printer driver transmits print data to the external controller 102 based on the print instruction from the user. Upon receiving the print instruction from the PC 103, the external controller 102 performs data analysis or rasterization processing, inputs print data to the image forming apparatus 101, and inputs a print instruction.

The image forming apparatus 101 will be described next. A plurality of apparatuses having different functions are connected to the image forming apparatus 101 such that complex print processing such as bookbinding can be performed. The plurality of apparatuses having different functions are, for example, a printing apparatus 107, an inserter 108, an inspection apparatus 109, a large capacity stacker 110, and a finisher 111.

The printing apparatus 107 forms an image using toner on a medium (to be also referred to as a sheet hereinafter) before printing, which is conveyed from a sheet feed unit located in the lower portion of the printing apparatus 107. The sheet the image formed thereon will also be referred to as a print sheet hereinafter. The inserter 108 inserts an insertion sheet into a printed product printed by the printing apparatus 107. That is, the inserter 108 can insert a sheet between arbitrary sheets of a print sheet group printed by the printing apparatus 107 and conveyed.

The inspection apparatus 109 captures an image of a conveyed print sheet and compares it with a correct answer image registered in advance, thereby determining whether the printed image is normal or not. The large capacity stacker 110 is a stacker capable of stacking a large number of print sheets. The finisher 111 performs finishing processing for a conveyed print sheet. For example, the finisher 111 can perform finishing processing such as stapling, punching, or saddle stitching for a print sheet. In addition, the finisher 111 discharges the print sheet that has undergone the finishing processing to a discharge tray.

Note that the image forming system 100 has a configuration with the external controller 102 connected to the image forming apparatus 101, but the configuration is not limited to this. That is, the image forming system 100 may have a configuration in which the image forming apparatus 101 is connected to the external LAN 104 and processible print data is transmitted from the client PC 103 connected to the external LAN 104 to the image forming apparatus 101. Alternatively, the image forming system 100 may be configured to read out print data from an HDD 221 (to be described later) inside the printing apparatus 107. In this case, in the image forming apparatus 101, data analysis and rasterization processing are performed, and print processing is executed.

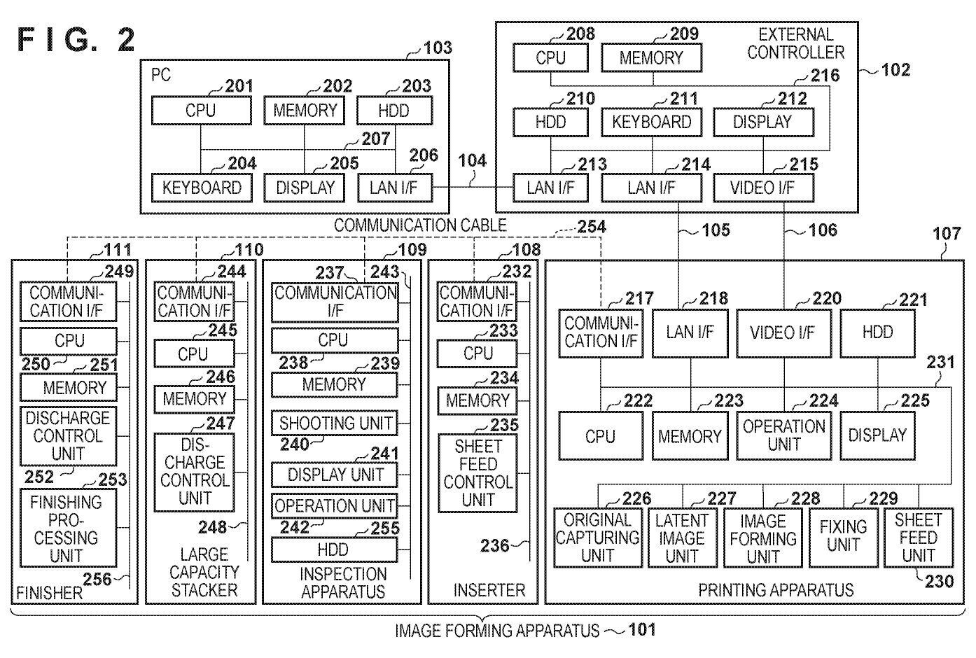

The blocks of the image forming apparatus 101, the external controller 102, and the client PC 103 will be described with reference to FIG. 2. First, the configuration of the printing apparatus 107 of the image forming apparatus 101 will be described. The printing apparatus 107 of the image forming apparatus 101 is configured to include a communication I/F 217, a LAN I/F 218, a video I/F 220, the HDD 221, a CPU 222, a memory 223, an operation unit 224, and a display 225. Furthermore, the printing apparatus 107 is configured to include an original capturing unit 226, a latent image unit 227, an image forming unit 228, a fixing unit 229, and a sheet feed/conveying unit 230. The constituent parts are connected to each other via a system bus 231.

The communication I/F 217 is configured to include a communication module and connected to the inserter 108, the inspection apparatus 109, the large capacity stacker 110, and the finisher 111 via a communication cable 254. By this connection, communication for controlling each apparatus is executed. The LAN I/F 218 is configured to include, for example, a Network Interface Card (NIC) and connected to the external controller 102 via the internal LAN 105. By this connection, communication of print data or the like is performed. The video I/F 220 is configured to include a module that communicates a video signal and connected to the external controller 102 via the video cable 106. By this connection, communication of image data or the like is performed.

The HDD 221 is a storage device that stores programs and data. The CPU 222 comprehensively performs image processing control and print control based on the programs and the like stored in the HDD 221. The memory 223 stores programs and image data necessary for the CPU 222 to perform various kinds of processing, and operates as a work area. The operation unit 224 includes, for example, buttons that can be pressed and accepts input of various kinds of settings and operation instructions from the user. The display 225 displays the setting information of the printing apparatus 107 and the processing state of a print job. Note that the printing apparatus 107 may be provided with a touch panel display that functions as both the operation unit 224 and the display 225.

The original capturing unit 226 is configured to include an image sensor and an exposure lamp and performs processing of capturing an original when using a copy function or scan function. That is, the original capturing unit 226 shoots an image by a CMOS image sensor while irradiating a print sheet set by the user with the exposure lamp. The original capturing unit 226 thus captures original data. The latent image unit 227 is a device that performs primary charge or laser exposure to irradiate a photosensitive drum with a laser beam to develop a toner image. In the latent image unit 227, first, primary charge is performed to charge the photosensitive drum surface with an even negative potential. Next, a laser driver irradiates the photosensitive drum with a laser beam while adjusting the reflection angle by a polygon mirror. An electrostatic latent image is thus formed.

The image forming unit 228 is a device for transferring toner to a sheet. The image forming unit 228 is formed by a developing unit, a transfer unit, a toner replenishing unit, and the like, and transfers toner on the photosensitive drum to a sheet. In the developing unit, negatively charged toner from a developing cylinder is attached to the electrostatic latent image on the photosensitive drum surface, thereby visualizing the image. The transfer unit performs primary transfer of applying a positive potential to a primary transfer roller and transferring the toner on the photosensitive drum surface to a transfer belt and secondary transfer of applying a positive potential to a secondary transfer roller and transferring the toner on the transfer belt to a sheet. The fixing unit 229 is a device for melting and fixing the toner on the sheet to the sheet by heat and pressure, and is formed by a heater, a fixing belt, a pressurizing belt, and the like. The sheet feed/conveying unit 230 is a device for feeding a sheet and controls a sheet feed operation and a conveyance operation using rollers and various kinds of sensors.

The configuration of the inserter 108 of the image forming apparatus 101 will be described next. The inserter 108 is configured to include a communication I/F 232, a CPU 233, a memory 234, and a sheet feed control unit 235. The constituent parts are connected to each other via a system bus 236.

The communication I/F 232 is configured to include a communication module and connected to the printing apparatus 107 via the communication cable 254. By this connection, communication necessary for control is performed. The CPU 233 performs various kinds of control necessary for sheet feed in accordance with a control program stored in the memory 234. The memory 234 is a storage device that stores control programs. The sheet feed control unit 235 controls the sheet feed unit of the inserter 108 and feed and conveyance of a sheet conveyed from the printing apparatus 107 while controlling rollers and sensors based on an instruction from the CPU 233.

The configuration of the inspection apparatus 109 of the image forming apparatus 101 will be described next. The inspection apparatus 109 is configured to include a communication I/F 237, a CPU 238, a memory 239, a shooting unit 240, a display unit 241, an operation unit 242, and an HDD 255. The constituent parts are connected to each other via a system bus 243. The communication I/F 237 is configured to include a communication module and connected to the printing apparatus 107 via the communication cable 254. By this connection, communication necessary for control is performed. The CPU 238 performs various kinds of control necessary for inspection in accordance with a control program stored in the memory 239. The memory 239 is a storage device that stores control programs. The shooting unit 240 is configured to include a shooting module and shoots an image of a conveyed print sheet based on an instruction of the CPU 238.

The CPU 238 stores an image including an inspection reference sheet as a correct answer image in the memory 239. Furthermore, the CPU 238 compares an inspection image including an inspection target print sheet (an example of "inspection target sheet") with the correct answer image stored in the memory 239 and determines whether the inspection image is normal or not. Note that the image including the inspection reference sheet and the inspection image are shot by the shooting unit 240 in advance.

The display unit 241 is configured to include a display and displays an inspection result, a setting item, or the like. The operation unit 242 is configured to include, for example, buttons that can be pressed by the user and accepts an operation instruction to change a setting of the inspection apparatus 109 or register a correct answer image. Note that the inspection apparatus 109 may be provided with a touch panel display that functions as both the operation unit 242 and the display unit 241. The HDD 255 stores various kinds of setting information and images necessary for inspection. The stored various kinds of setting information and images can be reused.

The configuration of the large capacity stacker 110 of the image forming apparatus 101 will be described next. The large capacity stacker 110 is configured to include a communication I/F 244, a CPU 245, a memory 246, and a discharge control unit 247. The constituent parts are connected to each other via a system bus 248. The communication I/F 244 is configured to include a communication module and connected to the printing apparatus 107 via the communication cable 254. By this connection, communication necessary for control is performed. The CPU 245 performs various kinds of control necessary for discharge in accordance with a control program stored in the memory 246. The memory 246 is a storage device that stores control programs. The discharge control unit 247 performs control of conveying a conveyed print sheet to a stack tray, an escape tray, or the subsequent finisher 111 based on an instruction from the CPU 245.

The configuration of the finisher 111 of the image forming apparatus 101 will be described next. The finisher 111 is configured to include a communication I/F 249, a CPU 250, a memory 251, a discharge control unit 252, and a finishing processing unit 253. The constituent parts are connected to each other via a system bus 256.

The communication I/F 249 is configured to include a communication module and connected to the printing apparatus 107 via the communication cable 254. By this connection, communication necessary for control is performed. The CPU 250 performs various kinds of control necessary for finishing or discharge in accordance with a control program stored in the memory 251. The memory 251 is a storage device that stores control programs. The discharge control unit 252 controls conveyance and discharge of a print sheet based on an instruction from the CPU 250. The finishing processing unit 253 controls finishing processing such as stapling, punching, or saddle stitching based on an instruction from the CPU 250.

The configuration of the external controller 102 will be described next. The external controller 102 is configured to include a CPU 208, a memory 209, an HDD 210, a keyboard 211, a display 212, a LAN I/F 213, a LAN I/F 214, and a video I/F 215. The constituent parts are connected to each other via a system bus 216.

The CPU 208 executes reception of print data from the client PC 103 based on a program and data stored in the HDD 210. In addition, the CPU 208 comprehensively executes processing such as Raster Image Processor (RIP) processing and transmission of print data to the image forming apparatus 101. The CPU 208 can also perform RIP processing for correct answer image data. More specifically, in RIP processing for correct answer image data, for example, an image is generated by converting a resolution of 600 dpi to 300 dpi, and in RIP processing for print data, an image is generated without lowering the resolution.

The memory 209 stores programs and data necessary for the CPU 208 to perform various kinds of processing, and operates as a work area. The HDD 210 stores programs and data necessary for operations such as print processing. The keyboard 211 is a device configured to input an operation instruction of the external controller 102. The display 212 displays the information of an execution application and the like of the external controller 102 by a still image or a video signal of a moving image.

The LAN I/F 213 is configured to include, for example, a NIC and connected to the client PC 103 via the external LAN 104. By this connection, communication of a print instruction or the like is performed. The LAN I/F 214 is configured to include, for example, a NIC and connected to the image forming apparatus 101 via the internal LAN 105, and communication of a print instruction or the like is performed. The external controller 102 can exchange various kinds of data with the printing apparatus 107, the inserter 108, the inspection apparatus 109, the large capacity stacker 110, and the finisher 111 via the internal LAN 105 and the communication cable 254. The video I/F 215 is configured to include a module that communicates a video signal and connected to the image forming apparatus 101 via the video cable 106. By this connection, communication of print data or the like is performed.

The configuration of the client PC 103 will be described next. The client PC 103 is configured to include a CPU 201, a memory 202, an HDD 203, a keyboard 204, a display 205, and a LAN I/F 206. The constituent parts are connected to each other via a system bus 207.

The CPU 201 executes print data generation and print instruction based on a document processing program stored in the HDD 203. In addition, the CPU 201 comprehensively controls the devices connected to the system bus. The memory 202 stores programs and data necessary for the CPU 201 to perform various kinds of processing, and operates as a work area. The HDD 203 stores programs and data necessary for operations such as print processing.

The keyboard 204 is a device configured to input an operation instruction of the PC 103. The display 205 displays the information of an execution application and the like of the client PC 103 by a still image or a video signal of a moving image. The LAN I/F 206 is configured to include, for example, a NIC and connected to the external LAN 104. By this connection, communication of a print instruction, RIP image reception, or the like is performed. Note that in the embodiment, the CPU 238 of the inspection apparatus 109 calculates a toner application amount in printing. The CPU 201 may receive the toner application amount from the printing apparatus 107 or the external controller 102 via the communication cable 254.

In the above explanation, the external controller 102 and the image forming apparatus 101 are connected via the internal LAN 105 and the video cable 106, but the configuration is not limited to this if data necessary for printing can be transmitted/received. For example, the external controller 102 and the image forming apparatus 101 may be connected only via the video cable. The memories 202, 209, 223, 234, 239, 246, and 251 each need only be a storage device configured to hold data and programs. For example, each memory may be replaced with a volatile RAM, a nonvolatile ROM, an internal HDD, an external HDD, or a USB memory.

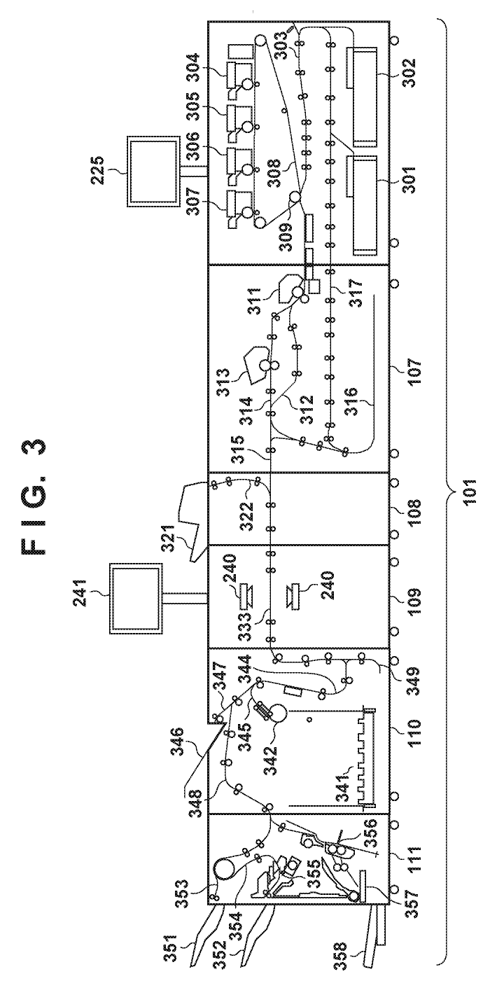

The internal structure of the image forming apparatus 101 will be described with reference to FIG. 3. The printing apparatus 107 is an apparatus that forms an image to be printed on a sheet, and is configured to include sheet feed decks (301 and 302), a sheet conveyance path 303, developing stations 304 to 307, an intermediate transfer belt 308, and the display 225. The printing apparatus 107 is also configured to include a fixing unit 311, sheet conveyance paths (312, 314, and 315), a second fixing unit 313, a sheet reversing path 316, and a double-sided conveyance path 317.

The sheet feed decks (301 and 302) can store various kinds of sheets. Also, the sheet feed decks (301 and 302) can separate only the uppermost one of the stored sheets and convey it to the sheet conveyance path 303. To form a color image, the developing stations 304 to 307 form toner images using Y, M, C, and K color toners, respectively. The toner images formed there are primarily transferred to the intermediate transfer belt 308. The intermediate transfer belt 308 rotates clockwise in FIG. 3. At a secondary transfer position 309, each toner image is then transferred to a sheet conveyed from the sheet conveyance path 303. The display 225 displays the print state of the image forming apparatus 101 or information for setting.

The fixing unit 311 fixes the toner image to the sheet. The fixing unit 311 is configured to include a pressurizing roller and a heating roller and melts/press-fits the toner to the sheet passing between the rollers, thereby fixing the toner image. The sheet that has gone through the fixing unit 311 is conveyed to the sheet conveyance path 315 via the sheet conveyance path 312. If further melting/press-fitting is necessary for fitting because of the type of the sheet, after passing through the fixing unit 311, the sheet is conveyed to the second fixing unit 313 using the sheet conveyance path 314 provided above the sheet conveyance path 312. Then, the sheet that has undergone the additional melting/press-fitting by the second fixing unit 313 is conveyed to the sheet conveyance path 315 via the sheet conveyance path 314. Note that if the image formation mode is a double-sided mode, the sheet is conveyed to the sheet reversing path 316, reversed through the sheet reversing path 316, and conveyed to the double-sided conveyance path 317, and an image is transferred to the second surface at the secondary transfer position 309.

The inserter 108 is configured to include an inserter tray 321, and joins a sheet placed on the inserter tray 321 to the conveyance path via a sheet conveyance path 322. The inserter 108 can thus insert a sheet between arbitrary sheets of a group of a series of sheets conveyed from the printing apparatus 107 and convey it to the subsequent apparatus.

The print sheet that has passed through the inserter 108 is conveyed to the inspection apparatus 109. The inspection apparatus 109 is configured to include the shooting units 240, the display unit 241, and a print sheet conveyance path 333. The shooting units 240 are arranged to face each other. The shooting units 240 are sensors configured to capture the obverse surface and the reverse surface of a print sheet. The inspection apparatus 109 can capture the image of the print sheet using the shooting units 240 at a timing when the print sheet conveyed to the print sheet conveyance path 333 reaches a predetermined position and determine whether the captured image is normal or not. The display unit 241 displays the result of inspection performed by the inspection apparatus 109.

More specifically, the inspection apparatus 109 inspects a sent print sheet image in accordance with preset inspection item. Note that in the following description, the print sheet image indicates a print sheet portion obtained by removing a background portion from a scan image by the CPU 238 of the inspection apparatus 109. The inspection of the print sheet image is performed by comparing a preset correct answer image with the sent print sheet image. As the image comparison method, a method of comparing pixel values at each pixel position, comparison of object positions by edge detection, character data extraction by Optical Character Recognition (OCR), or the like can be used. The inspection item is a corner crease of a print sheet. In addition, for example, a print position deviation, an image hue, an image density, a stripe, a blur, or printing omission may be inspection items.

The large capacity stacker 110 is configured to include a stack tray 341, a discharge reversing unit 342, print sheet conveyance paths (344, 345, 347, and 348), and an escape tray 346. The large capacity stacker 110 is a stacker capable of stacking a large number of print sheets.

The stack tray 341 is a tray on which a print sheet is stacked. A print sheet that has passed through the inspection apparatus 109 is input to the large capacity stacker 110 via the print sheet conveyance path 344. The print sheet is conveyed from the print sheet conveyance path 344, passes through the print sheet conveyance path 345, and is then stacked on the stack tray 341. The escape tray 346 is a discharge tray used to discharge a print sheet determined as abnormal by the inspection apparatus 109. The print sheet to be output to the escape tray 346 is conveyed from the print sheet conveyance path 344 via the print sheet conveyance path 347. Note that when conveying the print sheet to a post-processing apparatus of the subsequent stage of the large capacity stacker 110, the print sheet is conveyed via the print sheet conveyance path 348.

The discharge reversing unit 342 is used to stack a print sheet on the stack tray 341. The discharge reversing unit 342 reverses the print sheet to be input to the stack tray 341 such that the direction of the input print sheet is the same as the direction of the print sheet at the time of output. On the other hand, when conveying the print sheet stacked on the stack tray 341 to the escape tray 346 or the post-processing apparatus of the subsequent stage, the discharge reversing unit 342 directly discharges the print sheet without reversing it and flipping it at the time of stacking.

The finisher 111 is configured to include two discharge trays (351 and 352), print sheet conveyance paths (353, 354, and 357), processing units (355 and 356), and a saddle stitching tray 358. In accordance with a function designated by the user, the finisher 111 applies finishing processing to the conveyed print sheet. More specifically, the finisher 111 has finishing functions such as stapling (one-point/two-point stapling), punching (two holes/three holes), and saddle stitching.

The print sheet that has undergone the finishing processing is output to the discharge tray 351 via the print sheet conveyance path 353. However, finishing processing such as stapling cannot be performed on the print sheet conveyance path 353. To perform finishing processing such as stapling, the print sheet passes through the print sheet conveyance path 354. A finishing function designated by the user is executed by the processing unit 355, and the print sheet is then output to the discharge tray 352. The discharge trays (351 and 352) can move up and down. That is, the discharge tray 351 can operate such that the print sheet that has undergone the finishing processing by the processing unit 355 is stacked on the discharge tray 351 by lowering the discharge tray 351.

If saddle stitching is designated, the saddle stitching processing unit 356 performs stapling processing for the center of the print sheets and folds the print sheets in half. After that, the print sheets that have undergone the saddle stitching are output to the saddle stitching tray 358 via the print sheet conveyance path 357. The saddle stitching tray 358 has a belt conveyor structure. The saddle-stitched bundle stacked on the saddle stitching tray 358 is conveyed to the left side in FIG. 3.

### Overall Procedure of Inspection Processing

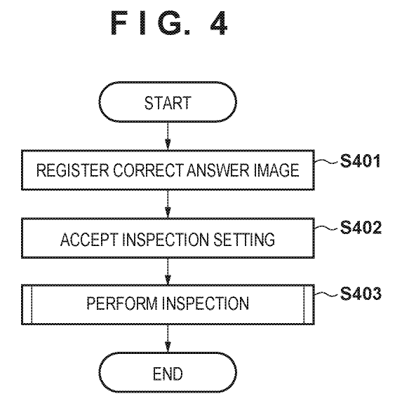

The overall procedure from a work before the start of inspection up to execution of inspection in the inspection apparatus 109 will be described next with reference to FIG. 4. Note that this processing is implemented by the CPU 238 of the inspection apparatus 109 reading out a program stored in the memory 239 and executing it.

In step S401, the CPU 238 registers a reference image (to be also referred to as a correct answer image hereinafter) used to determine whether an inspection target print sheet is normal. That is, the CPU 238 uses, as the correct answer image, a simulation image generated using print data or scan data generated by scanning a reference sheet in advance by the inspection apparatus 109. Note that the print data is received in advance using the communication I/F 237. Also, the CPU 238 acquires feature points of the reference sheet included in the correct answer image and stores these in the HDD 255 together with the correct answer image data. The feature points are top eight points out of feature points detected by, for example, Harris corner detection. However, Harris corner detection is an example of feature point detection, and the feature point acquisition method is not limited to this. Note that the feature points of the reference sheet included in the correct answer image will also be referred to as reference feature points hereinafter.

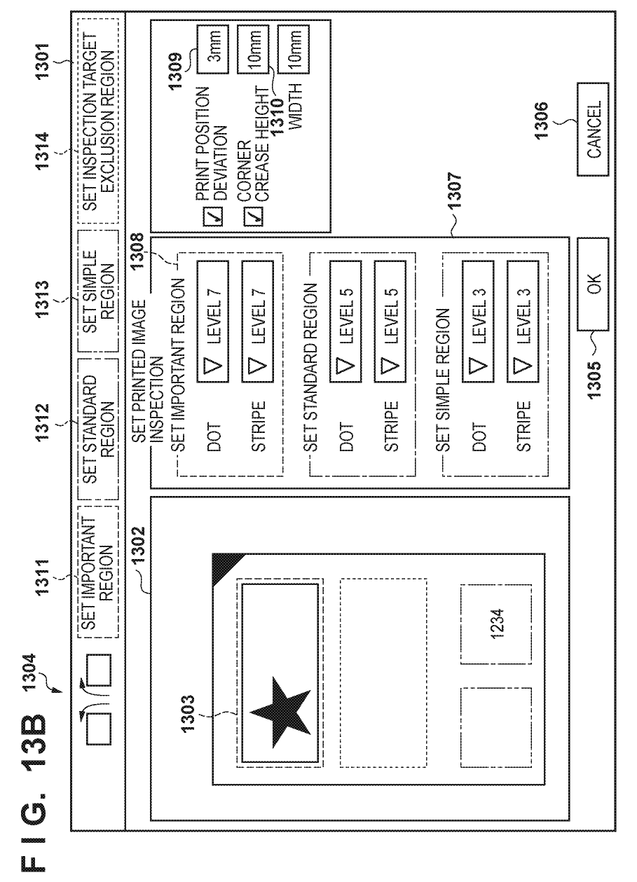

In step S402, the CPU 238 accepts an operation input from the user to the operation unit 242 and performs detailed inspection setting such as setting of an inspection level for a stripe or a blur, setting of an inspection type, or setting of an inspection region. Note that this setting is executed using an inspection UI (see FIGS. 13A and 13B) displayed on the panel of the operation unit 242. Various kinds of setting contents shown in FIGS. 13A and 13B will be described later. In step S403, the CPU 238 executes inspection. The CPU 238 compares the correct answer image generated in step S401 with the scan image of the inspection target print sheet, thereby executing inspection to determine, based on the inspection setting set in step S402, whether the print sheet has a corner crease abnormality. Also, the CPU 238 executes inspection other than the corner crease set by the inspection setting. The processing is thus ended.

### Inspection Processing

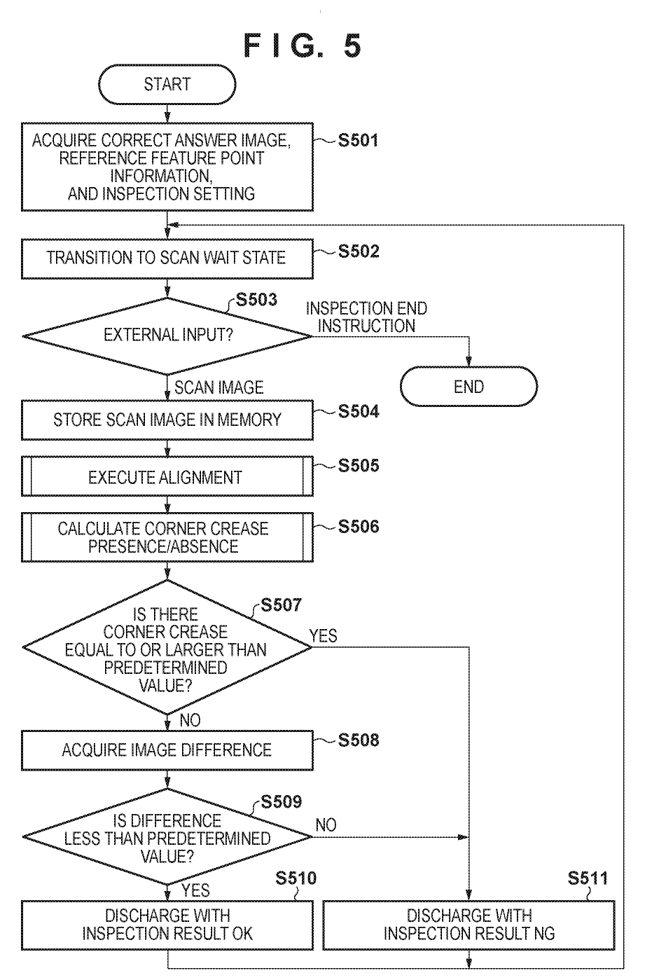

A flowchart showing the procedure of inspection processing in the inspection apparatus 109 will be described with reference to FIG. 5. Note that this processing is implemented by the CPU 238 of the inspection apparatus 109 reading out a program stored in the memory 239 and executing it.

In step S501, the CPU 238 acquires a correct answer image, information of reference feature points, and an inspection setting, like steps S401 and S402. In step S502, the CPU 238 transitions to a scan wait state. Inputs to be accepted in the scan wait state are two types of external inputs including image scan and inspection end instruction. In step S503, the CPU 238 determines whether an external input exists. If the CPU 238 determines that an inspection end instruction is received, the processing is ended. On the other hand, if the CPU 238 determines that an image scan input is received, the process advances to step S504.

In step S504, if the CPU 238 is in the scan wait state, the shooting unit 240 waits in a state in which it can always scan a print sheet. When the printing apparatus 107 executes printing, and the print sheet passes through the shooting unit 240, the shooting unit 240 scans the print sheet. The CPU 238 (an example of "acquisition unit") stores, in the memory 239, the scan image captured by the shooting unit 240.

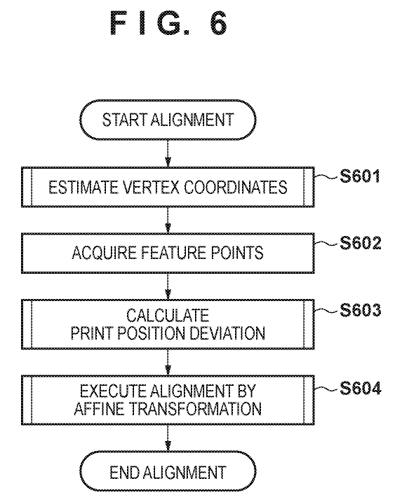

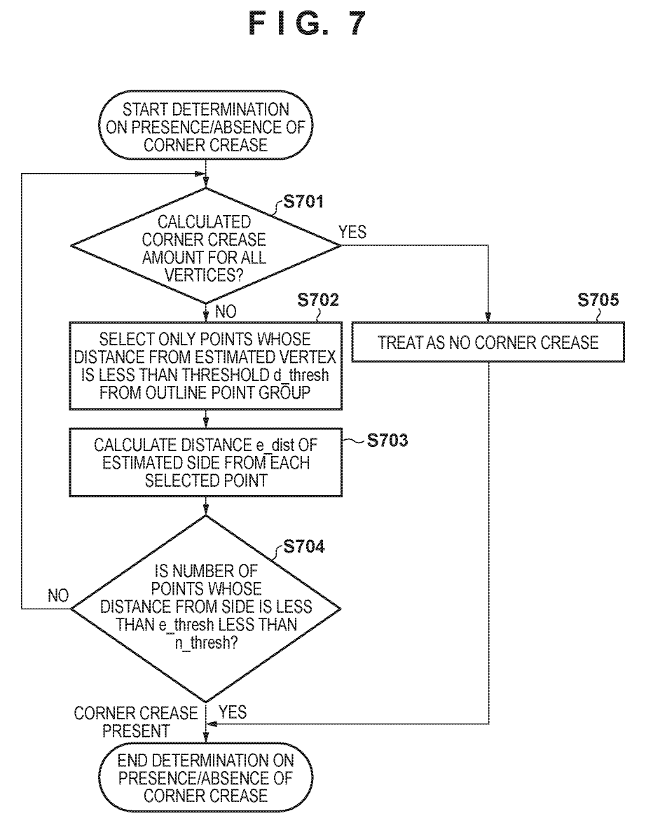

In step S505, the CPU 238 executes alignment of the print sheet image stored in the memory 239 with respect to the correct answer image. That is, the CPU 238 executes alignment by Affine transformation using the feature points of each image (details will be described later with reference to FIG. 6). Note that if a threshold 1309 (FIG. 13A) of a print position deviation is set, and the position deviation between the correct answer image and the print sheet image is equal to or larger than the threshold, alignment is executed. In step S506, the CPU 238 calculates a numerical value associated with a corner crease of the print sheet using coordinates and numerical values calculated at the time of alignment in step S505 (details will be described later with reference to FIG. 7). Note that the corner crease indicates a state in which a vertex portion of a print sheet is bent and the bent portion overlaps the sheet and is not captured in the scan image.

In step S507, using the numerical value calculated in step S506, the CPU 238 determines the presence/absence of a corner crease equal to or larger than a predetermined value. If the CPU 238 determines that there is a corner crease equal to or larger than the predetermined value, the scan image is determined as an abnormal image, and the process advances to step S511. In step S511, the CPU 238 instructs the large capacity stacker 110 to discharge the print sheet as an abnormal print sheet to the escape tray 346.

On the other hand, if the CPU 238 determines, in step S507, that there is no corner crease equal to or larger than the predetermined value, the process advances to step S508. In step S508, the CPU 238 detects an abnormality of a pattern included in the scan image. That is, the CPU 238 acquires an image difference between the correct answer image and the alignment image generated in step S505. The image difference includes, for example, a difference generated when the corner crease portion overlaps the pattern. Also, the image difference includes, for example, a difference generated by dirt (so-called a dot or a stripe) adhered to the pattern.

In step S509, upon determining that the image difference detected in step S508 is equal to or larger than the predetermined value, the CPU 238 determines that the scan image is an abnormal image, and the process advances to step S511. In step S511, the CPU 238 instructs the large capacity stacker 110 to discharge the print sheet as an abnormal print sheet to the escape tray 346. On the other hand, if the CPU 238 determines that the image difference is less than the predetermined value, the process advances to step S510. In step S510, the CPU 238 instructs the large capacity stacker 110 to discharge the print sheet determined as a normal image to the stack tray 341. Thus, the inspection apparatus 109 executes alignment and then checks a corner crease and determines the presence/absence of an abnormality, thereby selectively deciding the discharge destination.

### Alignment

Details of the alignment processing of step S505 will be described with reference to FIG. 6. Note that this processing is implemented by the CPU 238 of the inspection apparatus 109 reading out a program stored in the memory 239 and executing it.

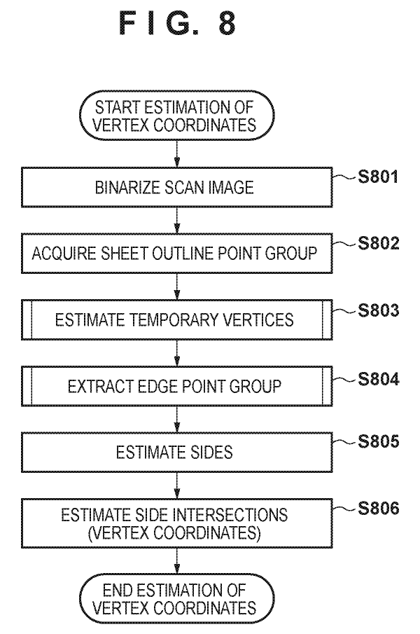

Alignment is roughly divided into four steps. First, in step S601, the CPU 238 estimates the vertex coordinates of the print sheet included in the scan image. The vertex coordinate estimation procedure will be described later with reference to FIG. 8. In step S602, the CPU 238 extracts the feature points of the pattern formed in the print sheet portion of the scan image. The print sheet portion of the scan image is a region surrounded by a line that connects the vertices estimated in step S601. To extract the feature points, for example, Harris corner detection is used.

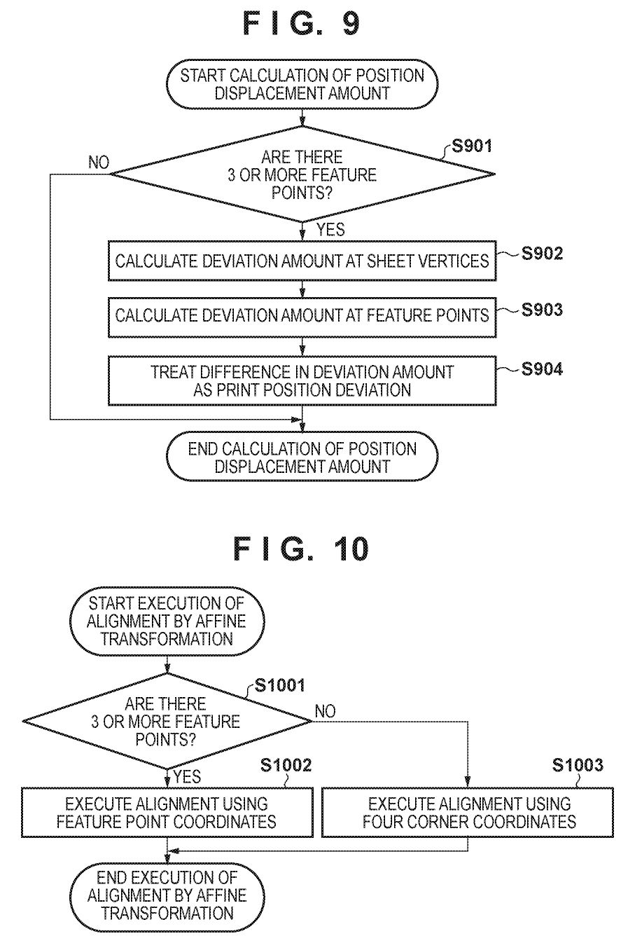

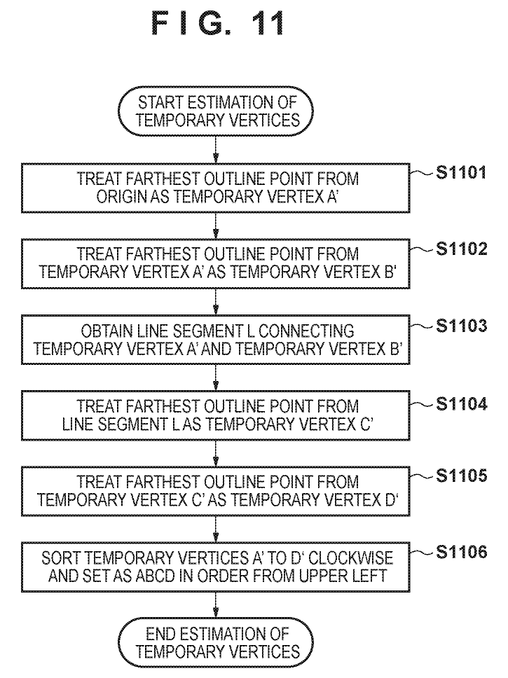

In step S603, the CPU 238 calculates a print position deviation amount. Details of the print position deviation and the procedure of calculation will be described later with reference to FIG. 9. In step S604, the CPU 238 performs Affine transformation using parameters obtained by the vertex estimation and feature point extraction and performs alignment. Details of step S604 will be described later with reference to FIG. 10. The processing is thus ended.

### Vertex Estimation

Vertex coordinate estimation processing of step S601 will be described later with reference to FIG. 8. Note that this processing is implemented by the CPU 238 of the inspection apparatus 109 reading out a program stored in the memory 239 and executing it.

In step S801, the CPU 238 binarizes the scan image. To binarize, for example, Otsu's binarization is used. At this time, if a binarization threshold is calculated using the entire scan image, the binarization threshold is readily affected by the pattern printed on the print sheet. Hence, the CPU 238 sets, for example, 100 pixels of the upper portion of the scan image to a Region Of Interest (ROI) and decides the binarization threshold.

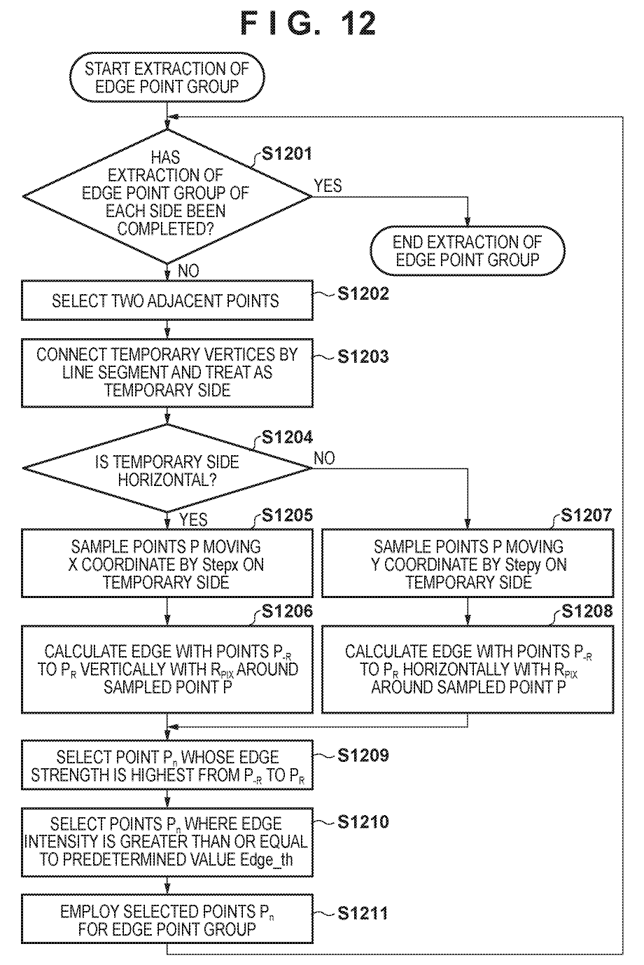

In step S802, the CPU 238 acquires the outline of the print sheet included in the scan image. The outline of the print sheet can be acquired by, for example, a chain code algorithm. In step S803, the CPU 238 acquires the vertices of the print sheet from a pixel group representing the acquired outline of the print sheet. Note that an acquired vertex will also be referred to as a temporary vertex hereinafter. An example of temporary vertices in a case where the print sheet is rectangular will be described later with reference to FIG. 11.

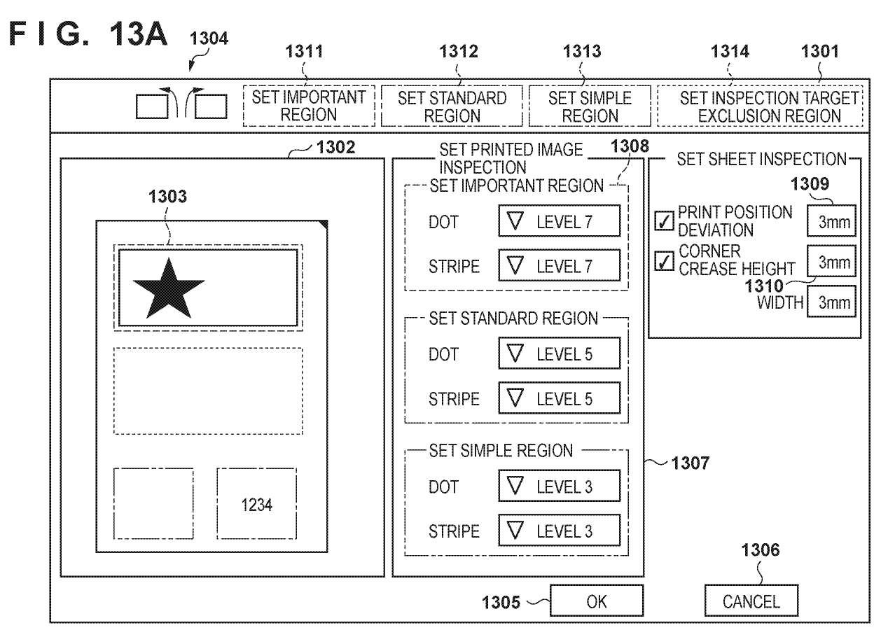

In step S804, the CPU 238 extracts a point group (to be also referred to as an edge point group hereinafter) representing the edge of at least a part of each side of the print sheet from the scan image using the temporary vertices. The processing of edge extraction will be described later with reference to FIG. 12. In step S805, using the extracted point group, the CPU 238 estimates the sides of the print sheet assumed to have no corner crease. Here, to estimate the sides, for example, the least squares method is used. In step S806, the CPU 238 calculates the intersections of the estimated sides. The calculated intersections are estimated to be the coordinates of the vertices of the print sheet. Note that the vertices will also be referred to as estimated vertices (an example of "second vertices") hereinafter. The processing is then ended. Note that this processing uses algorithms such as Otsu's binarization, chain code, and the least squares method. However, the algorithms are not limited to these, and other algorithms may be employed.

### Calculation of Position Deviation Amount

Details of position deviation amount calculation processing of step S603 will be described with reference to FIG. 9. Note that this processing is implemented by the CPU 238 of the inspection apparatus 109 reading out a program stored in the memory 239 and executing it.

In step S901, the CPU 238 determines whether the number of reference feature points is three or more. Here, the number of reference feature points is the number of feature points included in the correct answer image acquired in step S401. This aims at preventing the number of reference feature points from being counted more than the original number of feature points in a case where dirt or a flaw exists when feature points are extracted from an image including a print sheet. If the CPU 238 determines that there are three or more reference feature points, the process advances to step S902. Otherwise, the position deviation amount cannot be acquired because the number of reference feature points in the printed pattern is small, and the processing is thus ended.

In step S902, the CPU 238 calculates an Affine matrix for aligning the vertex coordinates of the print sheet included in the scan image with the vertex coordinates of the sheet included in the correct answer image. Using the Affine matrix, the absolute value of the motion vector of each vertex of the print sheet included in the scan image to be aligned with the correct answer image is calculated, and the absolute value is obtained as the deviation amount at the print sheet vertex.

In step S903, the CPU 238 calculates an Affine matrix for aligning the pattern included in the scan image with a reference pattern included in the correct answer image using the reference feature points of the correct answer image obtained in step S401 and the feature points of the print sheet portion of the scan image calculated in step S602. Using the Affine matrix, the CPU 238 calculates the motion vector of each vertex of the print sheet to be aligned with the correct answer image and obtains the absolute value of the motion vector as the deviation amount at the feature point.

In step S904, the CPU 238 calculates a print position deviation. The print position deviation is the difference between the motion vectors calculated in steps S902 and S903 at each vertex. The print position deviation amount of the print sheet is assumed to be the largest norm among the differences at the vertices. The processing is then ended.

### Details of Alignment

Alignment processing of step S604 will be described with reference to FIG. 10. Note that this processing is implemented by the CPU 238 of the inspection apparatus 109 reading out a program stored in the memory 239 and executing it.

In step S1001, the CPU 238 determines whether the number of feature points is three or more, like step S901. At this time, the counted feature points are the reference feature points of the correct answer image acquired in step S401. If the CPU 238 determines that the number of reference feature points is three or more, the process advances to step S1002. Otherwise, the process advances to step S1003.

In step S1002, the CPU 238 performs alignment of aligning the scan image with the correct answer image using an Affine matrix. This Affine matrix is the same as the matrix calculated in step S903. The processing is then ended. On the other hand, in step S1003, the CPU 238 performs alignment of aligning the scan image with the correct answer image using another Affine matrix. This Affine matrix is the same as the matrix calculated in step S902. The processing is then ended.

### Estimation of Temporary Vertices

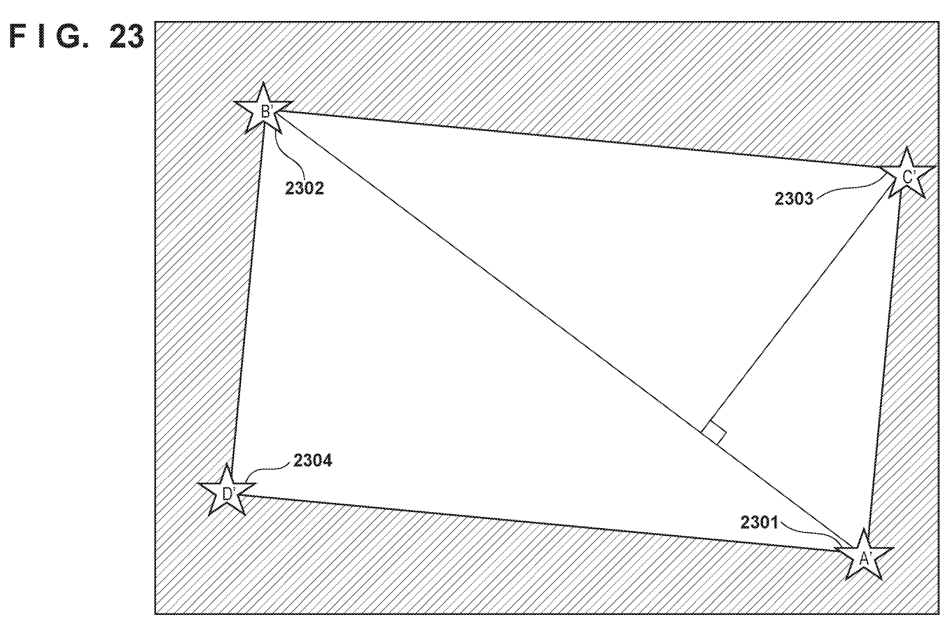

Temporary vertex estimation processing of step S803 will be described with reference to FIGS. 11 and 23. Note that this processing is implemented by the CPU 238 of the inspection apparatus 109 reading out a program stored in the memory 239 and executing it.

In step S1101, the CPU 238 sets the origin at, for example, the center of the captured image. The CPU 238 then decides, in the point group of the print sheet outline (the center points of pixels including the outline) acquired in step S802, the point farthest from the original coordinates as a temporary vertex A' 2301 (see FIG. 23, an example of "first point") of the print sheet. In step S1102, the CPU 238 decides, in the print sheet outline point group, the point farthest from the temporary vertex A' 2301 as a temporary vertex B' 2302 (an example of "second point").

In step S1103, the CPU 238 obtains a line segment L that connects the temporary vertex A' 2301 and the temporary vertex B' 2302. In step S1104, the CPU 238 decides, in the print sheet outline point group, the point farthest from the line segment L as a temporary vertex C' 2303 (an example of "third point"). In step S1105, the CPU 238 decides, in the print sheet outline point group, the point farthest from the temporary vertex C' as a temporary vertex D' 2304 (an example of "fourth point"). In step S1106, the CPU 238 sets, of the temporary vertices A', B', C', and D', the upper left temporary vertex to a temporary vertex A. A temporary vertex B, a temporary vertex C, and a temporary vertex D are sequentially set clockwise. If a corner crease occurs, the thus selected temporary vertices (an example of "first vertices") are not correct vertex coordinates but are vertex coordinates formed at positions different from original positions due to the corner crease. The processing is then ended.

### Extraction of Edge Point Group

Extraction processing of the edge point group of the print sheet in step S804 will be described with reference to FIG. 12. Note that this processing is implemented by the CPU 238 of the inspection apparatus 109 reading out a program stored in the memory 239 and executing it.

In step S1201, the CPU 238 determines whether edge extraction for the sides of the print sheet is completed. If the CPU 238 determines that the edge extraction is completed, the processing is ended. Otherwise, the process advances to step S1202. In step S1202, the CPU 238 selects two adjacent points of the temporary vertices A, B, C, and D obtained in step S803.

In step S1203, the CPU 238 connects the selected two points by a line segment to set a temporary side. In step S1204, the CPU 238 determines whether the temporary side is a horizontal side or a vertical side. If the CPU 238 determines that the temporary side is a horizontal side, the process advances to step S1205. If the CPU 238 determines that the temporary side is a vertical side, the process advances to step S1207.

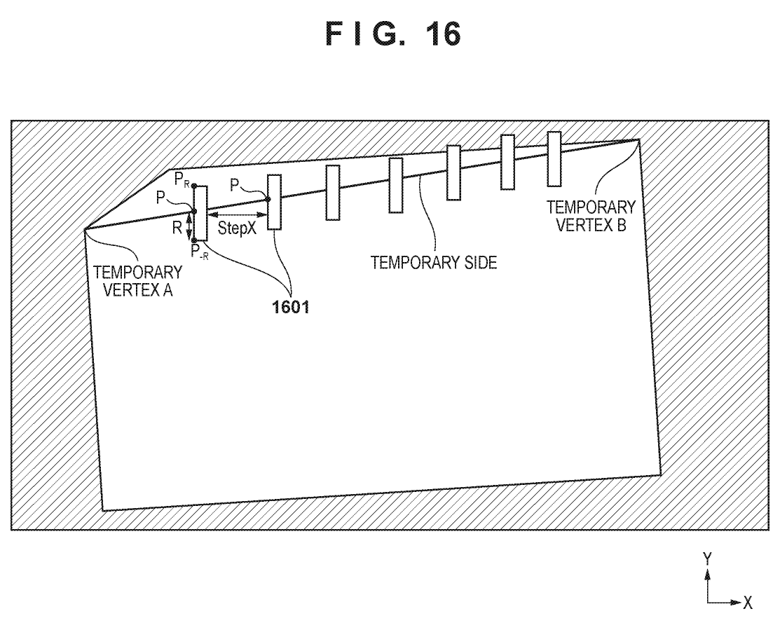

In step S1205, the CPU 238 extracts points P (an example of "fifth point") at an interval StepX (an example of "first interval") in the X direction on the temporary side (see FIG. 16). In step S1206, the CPU 238 sets, in each of the extracted points P, a point P_{-R} and a point P_{R} shifted in the Y direction orthogonal to the X direction. Then, the CPU 238 assumes a rectangle 1601 that has the point P_{-R} and the point P_{R} as vertices and has a small width in the X direction. The CPU 238 calculates an edge in the rectangle 1601 in a plurality of points (an example of "sixth point") arranged at a predetermined interval (an example of "second interval") from the point P_{-R} to the point P_{R}. Note that, for example, a secondary differentiation filter is used to calculate the edge. After that, the process advances to step S1209.

On the other hand, if the process advances to step S1207, the CPU 238 performs the process of step S1205 along the vertical side. Then, in step S1208, the CPU 238 performs the same processing as in step S1206. After that, the process advances to step S1209. In step S1209, the CPU 238 sets a point where the strongest luminance difference is detected in the edge calculated in the rectangle 1601 as Pn. The CPU 238 performs the setting of Pn for each point P set on the temporary side.

In step S1210, the CPU 238 selects an edge on which the edge strength of each point Pn is equal to or larger than a threshold Edge_th (an example of "not less than first threshold") and a corresponding point Pn. By this selection processing, a point other than the print sheet outline is prevented from being selected as an edge. That is, as shown in FIG. 16, Pn in the rectangle 1601 (the rectangle 1601 on the left side in FIG. 16) that does not overlap the outline of the print sheet is prevented from being selected. In step S1211, the CPU 238 employs all the thus selected points Pn as the points that form the edge point group. The process returns to step S1201, and the same processing as described above is executed concerning another side. Note that the alignment processing is performed assuming that the print sheet has a rectangular shape. However, the shape of the print sheet is not limited to the rectangular shape. For example, the print sheet may have a hexagonal shape, like an envelope.

### Determination of Presence/Absence of Corner Crease

Corner crease presence/absence determination processing of steps S506 and S507 in FIG. 5 will be described with reference to FIG. 7. Note that this processing is implemented by the CPU 238 of the inspection apparatus 109 reading out a program stored in the memory 239 and executing it.

In step S701, the CPU 238 determines whether determination of the presence/absence of a corner crease is completed for all vertices. If the CPU 238 determines that determination of the presence/absence of a corner crease is completed for all vertices, the processing is ended. On the other hand, otherwise, the process advances to step S702, and a corner crease amount is calculated.

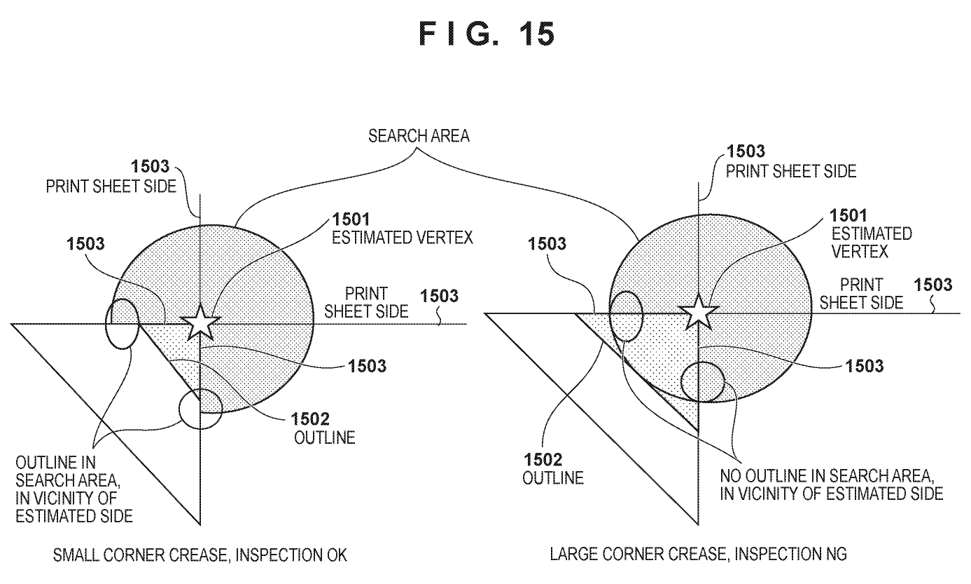

In step S702, the CPU 238 (an example of "setting unit") sets estimated vertex coordinates 1501 (see FIG. 15) calculated in step S601 to the reference point of the scan image. Then, the CPU 238 calculates the distance between the reference point and the actual print sheet. More specifically, the CPU 238 calculates an outline 1502 of the print sheet in accordance with the flowchart shown in FIG. 8. The distance between the center coordinates of each of the pixels forming the outline 1502 and the estimated vertex coordinates 1501 is obtained. The CPU 238 extracts pixels each having a distance less than a threshold d_thresh.

In step S703, the CPU 238 calculates a distance e_dist between the extracted pixels and a print sheet side 1503 (to be also referred to as an estimated side hereinafter) estimated when calculating the estimated vertices. In step S704, the CPU 238 counts the number of pixels whose distance e_dist is less than a distance threshold e_thresh. The CPU 238 then determines whether the number is less than a threshold n_thresh. If the CPU 238 determines that the number of pixels is less than the threshold n_thresh, the CPU 238 (an example of "determination unit") determines that the vertex has a corner crease, and the processing is ended. On the other hand, if the CPU 238 determines that the number of pixels is equal to or larger than the threshold n_thresh, the CPU 238 determines that the vertex has no corner crease, and the process returns to step S701. Note that in this processing, the estimated vertex of the print sheet is employed as the reference point. However, the reference point is not limited to this. The reference point may be, for example, the origin of the image after alignment.

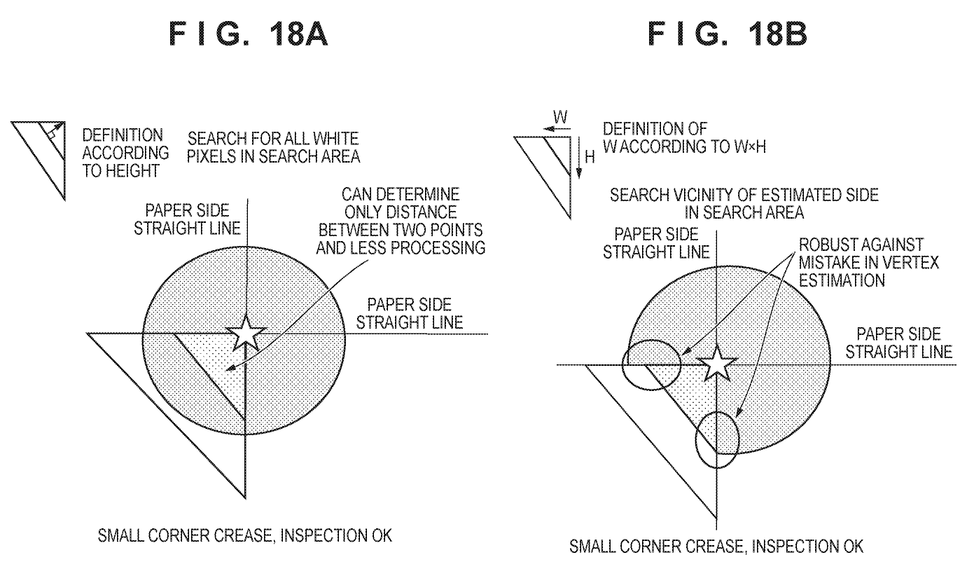

The effect of the corner crease amount calculation method as described above will be described with reference to FIGS. 15 and 18B. By executing step S702, the center coordinates of each pixel which forms the outline 1502 and whose distance from the estimated vertex 1501 (reference point) is less than the distance d_thresh are selected. Steps S703 and S704 are then executed. According to this method, even if the position of the estimated vertex includes an error, a corner crease is determined in accordance with the distance between the estimated side and the center coordinates of each selected pixel forming the outline 1502. It is therefore possible to reduce the influence of the error of the position of the estimated vertex on the corner crease determination accuracy. Note that the thresholds used in the processing shown in FIG. 7 are appropriately set using a width W and a height H of a corner crease, which are input in advance by the CPU 238 to a UI screen shown in FIG. 13A.

### Inspection Setting

A User Interface (UI) screen (an example of "setting screen capable of setting reference value of corner crease") configured to do settings of inspection will be described with reference to FIGS. 13A and 13B. A screen 1301 shown in FIG. 13A indicates a window of an inspection UI. The CPU 238 of the inspection apparatus 109 displays the inspection UI on the display unit 241. The user performs, on this screen, an operation of setting inspection regions including an important region, a standard region, and a simple inspection region. The important region is, for example, a region such as a human face for which abnormality inspection is executed particularly intensively as compared to other regions. The standard region is, for example, a region for which inspection is executed on standard. The simple inspection region is, for example, a region such as the reverse surface of a print sheet for which simple inspection suffices. Note that a method of setting three types of inspection regions has been exemplified as an example, but the region names and region types are not limited to these.

A screen 1302 indicates a preview screen. Here, a correct answer image registered in step S401 is displayed. The above-described inspection regions are set by drawing regions on the correct answer image. A region 1303 indicates an inspection region. The types of lines surrounding regions in FIG. 13A are the same as the line types of the frames of the four types of inspection region settings. For example, a dotted line surrounding the region 1303 is the same line type as that of a frame 1308 surrounding "important region setting".

A button 1304 indicates a rotation function. The user can rotate the preview screen by 90° by clicking the button 1304. As shown in FIG. 13A, there exist two buttons, and the user can select clockwise rotation and counterclockwise rotation.

A button 1305 is a button configured to save the inspection region settings. A button 1306 is a button configured to discard the inspection region settings. An inspection level setting 1307 is a UI for setting inspection levels. In three inspection region settings, that is, the important region setting, the standard region setting, and the simple region setting of the inspection level setting 1307, pull-down menus capable of adjusting the inspection levels are displayed. In accordance with the set inspection level, a threshold that is an inspection criterion for dirt or a flaw is set. The types of lines used for the frames 1308 of the three inspection region settings are different. On the preview screen 1302, frames corresponding to the three frames 1308 are displayed. That is, for example, the frame 1308 of the setting of the important region is formed by a broken line, and the region 1303 surrounded by a similar broken line is displayed in the upper portion of the preview screen. The region 1303 indicates an important region in inspection.

An inspection setting method will be described below with reference to FIGS. 13A and 13B. When performing inspection setting, the user designates a region to be inspected on the preview screen 1302. Here, the user performs a touch operation for buttons (1311 to 1314) displayed on the screen. That is, the user performs a touch operation in accordance with an inspection type to be set, and performs a drag-and-drop operation on the preview screen, thereby selecting the region 1303. Note that the frame line of the region at this time is the same as that of the selected inspection type.

Next, for each selected region, the user sets a reference value of inspection. That is, in the inspection level setting 1307, the user can set a reference value for each region. For example, if the important region is selected by the touch operation on the button 1311, the user sets the inspection reference value of the important region by operating the pull-down menu displayed in the region surrounded by the frame 1308. In FIG. 13A, for example, the user selects a pull-down menu corresponding to each of a dot (a dot-like abnormality printed on the print sheet) and a stripe (a linear abnormality printed on the print sheet), thereby selecting the inspection level.

A threshold 1309 of a print position deviation indicates a deviation amount allowable when a print position deviation occurs. When the user inputs the allowable maximum value in units of mm in the frame, the print position deviation can be inspected. Only when a checkmark is input to a check box displayed on the left side of the print position deviation, position deviation inspection is executed. Otherwise, position deviation inspection is not executed. Note that the print position deviation calculation method complies with the flowchart shown in FIG. 9.

A value (an example of "reference value of corner crease") input to a corner crease display 1310 indicates an amount allowable as inspection OK when a corner crease occurs. When the user inputs the allowable maximum values of the width W and the height H in units of mm in the frame, a corner crease can be inspected. Only when a checkmark is input to a check box displayed on the left side of the corner crease, corner crease inspection is executed. Otherwise, corner crease inspection is not executed. The method of calculating the presence/absence of a corner crease complies with the flowchart shown in FIG. 7.

Also, as indicated by the corner crease display 1310, when the user inputs the numerical values of a corner crease, a corner crease having a size indicated by the corner crease reference values is displayed on the preview screen 1302 (for example, at the upper right corner). Also, as shown in FIG. 13B, when the user changes the numerical values of the corner crease reference values, the size of the corner crease displayed on the preview screen 1302 also changes. This allows the user to set the degree of a corner crease as NG while visually recognizing it. The user performs a touch operation on the button 1305, thereby completing the inspection setting. Then, the CPU 238 accepts the inspection setting and saves it in the HDD 255.

### Display of Result

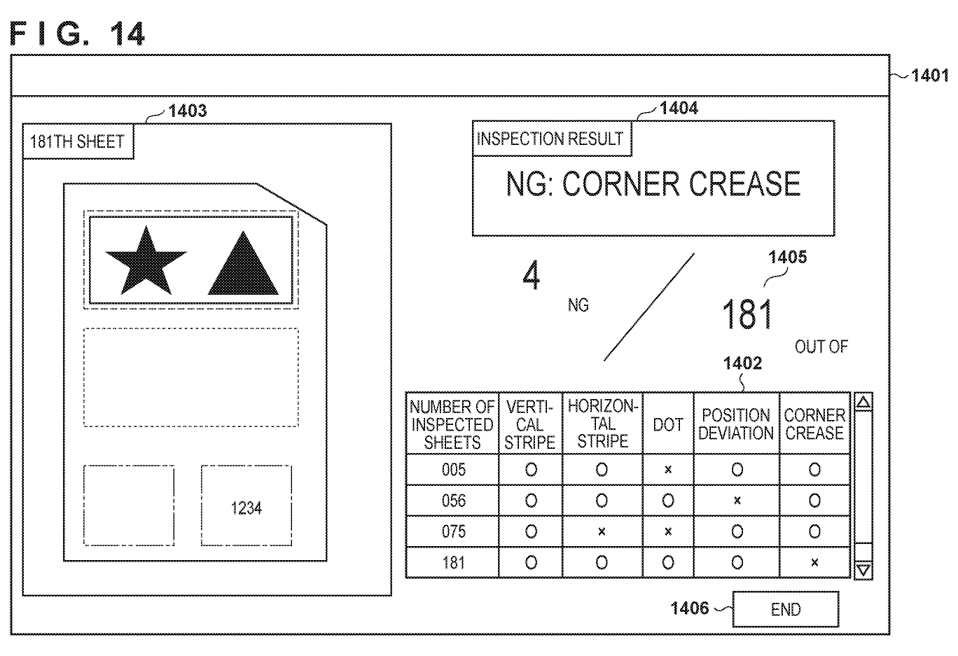

An inspection result UI screen that the CPU 238 of the inspection apparatus 109 displays on the display unit 241 will be described with reference to FIG. 14. This UI can visually be recognized both during inspection and after inspection. An inspection result window 1401 is displayed on the UI screen. On the inspection result window 1401, the user can confirm the result of the print sheet whose inspection is ended.

The inspection result window 1401 includes an inspection result list 1402. In the inspection result list 1402, results of already ended inspection are displayed. The user can confirm details of inspection by clicking the print sheet determined as abnormal (to be also referred to as an abnormal print sheet hereinafter) in the inspection result list 1402. In addition, causes for abnormality determination are displayed as a list in the inspection result list 1402. For example, concerning five types "vertical stripe", "horizontal stripe", "dot", "position deviation", and "corner crease", a "" mark is displayed if inspection is OK, and a "" mark is displayed if inspection is NG. The user can recognize details of the abnormality of the print sheet by these marks.

Also, the inspection result window 1401 includes a scan image display screen 1403 that is a region where the image of a scanned print sheet is displayed. Note that of the scanned print sheets, images including abnormal print sheets are stored in the HDD 255 in advance. When the user clicks, in the inspection result list 1402, an abnormal print sheet whose details are to be confirmed, the CPU 238 switches the scan image display screen 1403 to the image of the corresponding abnormal print sheet.

Also, the inspection result window 1401 includes an inspection result 1404. The inspection result 1404 displays the NG reason of the selected abnormal print sheet. The NG reason matches details displayed in the inspection result list 1402. The NG reason is, for example, vertical stripe, horizontal stripe, dot, position deviation, or corner crease. Note that the position deviation is the position deviation of the entire image of the formation target with respect to the print sheet. If a plurality of causes are detected, all the causes are displayed.

In addition, the inspection result window 1401 includes an inspection progress 1405. The inspection progress 1405 indicates the progress of current inspection. For example, the number of print sheets that have undergone the inspection is displayed as the denominator, and the number of print sheets determined as abnormal by the inspection is displayed as the numerator. Also, the inspection result window 1401 includes, at the lower right corner of the screen, an end button 1406 for closing the window. When the user performs a touch operation on the button, the window is closed. When the user performs a touch operation on the end button 1406 during inspection, inspection is executed up to the print sheet for which printing has already been started at the time of the operation, the inspection is ended after that, and the window is closed.

### ONE ASPECT OF FUNCTION/EFFECT

According to the image forming system 100, the user can input a determination criterion for the presence/absence of a corner crease to the inspection UI as shown in FIG. 13A. Hence, the user can set a corner crease determination criterion adapted to stacking on the stacker of print sheets. Also, if finishing processing is designated in a print job, a corner crease determination criterion adapted to the finishing processing can be set. Additionally, the user can set the determination criterion in accordance with the size of an image formed on a sheet. It is therefore possible to execute corner crease determination according to the user's intention.

In addition, according to the image forming system 100, the vertices of a print sheet are estimated, and the distance to a pixel representing the outline of the print sheet is calculated using the estimated vertex as a reference point, thereby inspecting the presence/absence of a corner crease. According to this inspection, the corner crease inspection accuracy improves.

Also, according to the image forming system 100, even if it is determined in step S507 that there is no corner crease more than the predetermined value, the abnormality of the pattern of the print sheet is determined in steps S508 and S509. Hence, even if a corner crease is small, a print sheet in which a corner crease overlaps a pattern can be determined as abnormal. According to the image forming system 100, processing can be executed while grasping the user's intention.

### First Modification

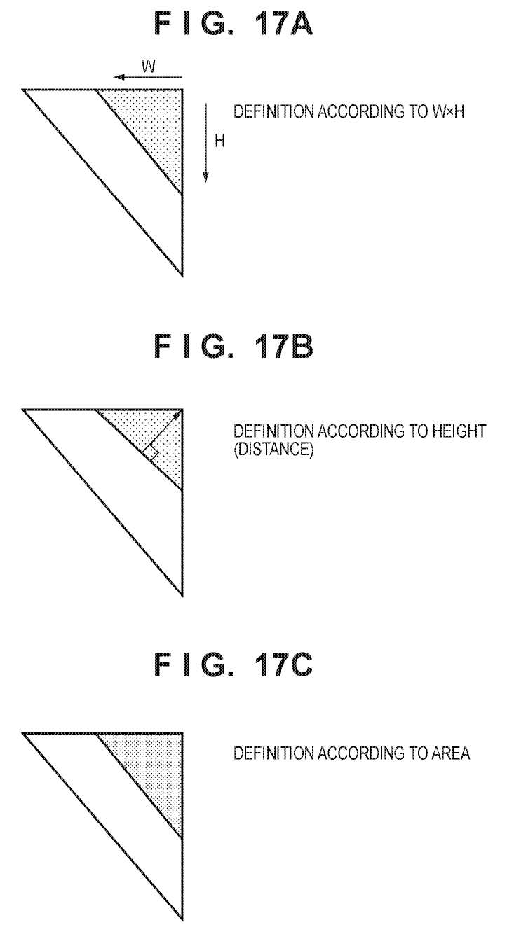

The corner crease determination criterion may be different from the criterion of the above embodiment. More specifically, step S702 shown in FIG. 7 in the above-described embodiment is executed in consideration of the length W in the horizontal direction and the length H in the vertical direction of the estimated side shown in FIG. 17A. On the other hand, FIGS. 17B, 17C, and 18A schematically exemplify a corner crease determination criterion according to the first modification. FIGS. 17B and 18A show an example in which a corner crease is assumed to have a triangular shape and the height of the triangle is used as the determination criterion. FIG. 17C shows an example in which the length W in the horizontal direction and the length H in the vertical direction of the estimated side are calculated, a corner crease is assumed to have a triangular shape, and the product of W and H, that is, the area of the corner crease portion is used as the determination criterion.

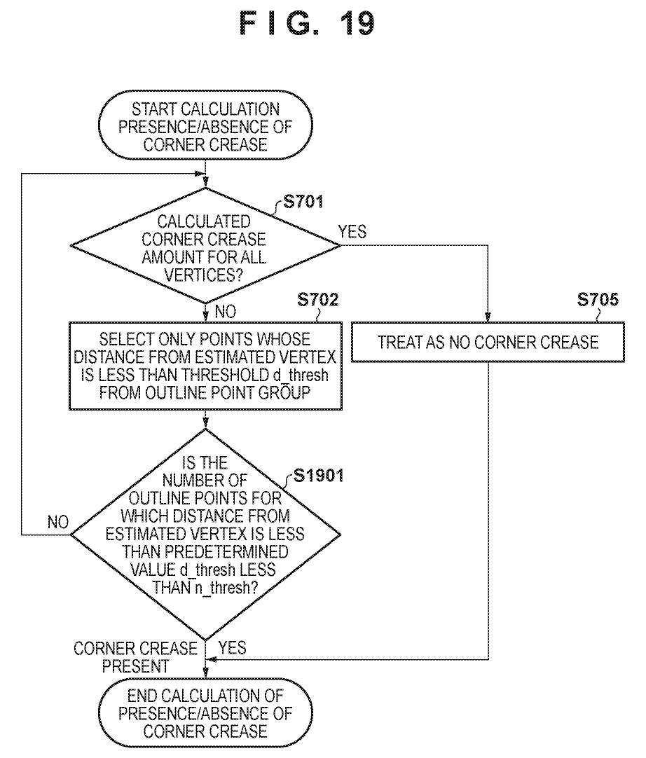

Corner crease determination processing using the height of the triangle shown in FIG. 17B will be described with reference to FIGS. 18A and 19. Note that this processing is implemented by the CPU 238 of the inspection apparatus 109 reading out a program stored in the memory 239 and executing it. The difference from FIG. 7 will mainly be described below.

In the procedure shown in FIG. 19, the process of step S703 is not executed. That is, after the process of step S702 is executed, in step S1901, the CPU 238 of the inspection apparatus 109 counts the number of points for which the distance between an estimated vertex and the center coordinates of each pixel forming the outline of the print sheet is less than the threshold d_thresh. The CPU 238 then determines whether the number is less than the threshold n_thresh. Upon determining that the number is less than the threshold n_thresh, the CPU 238 determines that the print sheet has a corner crease, and the processing is ended. On the other hand, otherwise, the process returns to step S701.

### ONE ASPECT OF FUNCTION/EFFECT

According to the corner crease determination method as shown in FIGS. 17B and 18A, since the process of step S703 is not executed as compared to the processing shown in FIG. 7, the processing speed can be improved. Also, according to the corner crease determination method as shown in FIG. 17C, without executing the processing shown in FIG. 7, corner crease determination can be executed by calculating the area of the corner crease portion from the lengths (W and H) of the estimated side. Hence, this determination method can also improve the processing speed.

### Second Modification

According to the above embodiment, a corner crease having a predetermined size or more can be determined as inspection NG in accordance with the input of the user. By the way, there is a case where, for example, a patch or the like is printed at an end portion when printing on a print sheet. In this case, to determine a corner crease that is assumed to overlap the patch as inspection NG, the user needs to set the size of a corner crease while being conscious of the positional relationship between the patch and the corner crease. Also, for example, depending on the sheet type, if a corner crease having a predetermined size or more exists in stacking, the corner crease portion is thicker than other print sheets without a corner crease and, therefore, it is impossible to stack the number of sheets that can originally be stacked. Hence, the user needs to set the allowable size of the corner crease while being conscious of the specifications of hardware. However, since the size changes depending on the sheet type or the specifications of hardware, the burden on the user is large. Hence, the second modification in which the burden on the user in setting the corner crease amount can be reduced in these cases will be described.

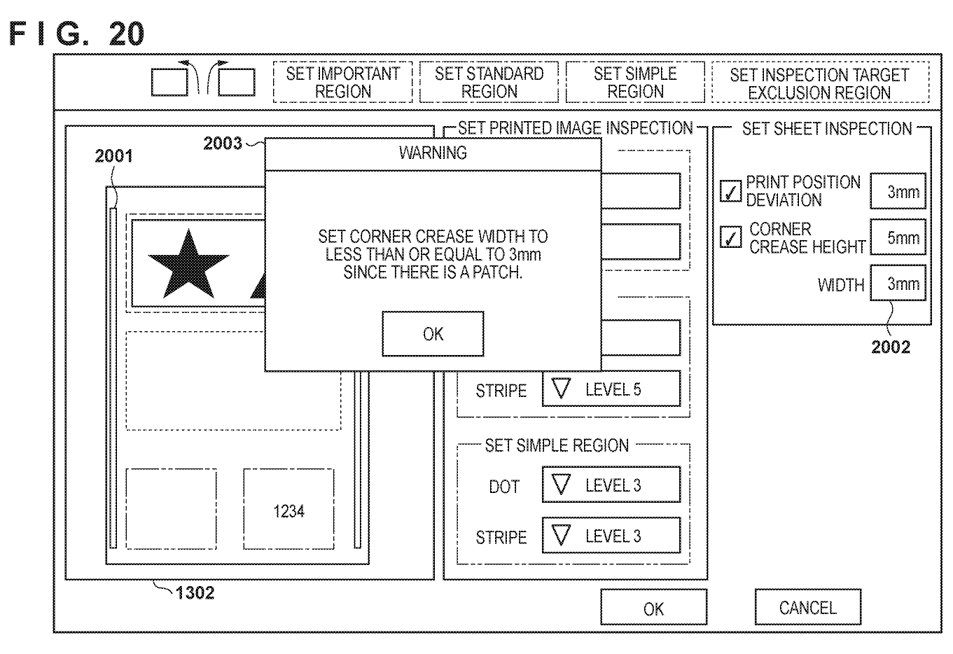

FIG. 20 shows a setting screen (an example of "first screen") displayed when, for example, forming a patch in the print sheet. A patch 2001 shown in the preview screen 1302 indicates a patch to be formed (an example of "print setting"). This patch is drawn in the correct answer image, and the CPU 238 of the inspection apparatus 109 acquires the position of the patch in the correct answer image when the correct answer image is registered. Also, the CPU 238 acquires the information of the sheet type and the like (an example of "print setting") and calculates the allowable corner crease amount. The upper limit of the allowable corner crease amount is, for example, 3 mm (an example of "settable range of reference value") based on the patch position as a reference.

A width setting frame 2002 provided in the sheet inspection setting field is a frame to which the user can input the width of a corner crease. Since the patch 2001 is located 3 mm at the sheet end, the user needs to set the width to 3 mm or less. Hence, if the user inputs a numerical value larger than 3 mm, the CPU 238 displays a warning 2003 to promote re-setting such that the setting of the corner crease width does not exceed 3 mm. Although not illustrated in FIG. 20, the CPU 238 may display the warning 2003 in a case where a numerical value larger than the allowable corner crease width according to the specifications of the sheet stacking tray is input.

### One Aspect of Function/Effect

According to the image forming system 100 of the second modification, when setting the corner crease amount such that a corner crease and a patch do not overlap or when setting the corner crease amount according to the specifications of hardware, the burden on the user can be reduced.

### Third Modification

According to the above embodiment, a corner crease having a predetermined size or more can be determined as inspection NG in accordance with the input of the user. By the way, if factors such as the temperature/humidity of the execution environment and large curl of a sheet are combined, a corner crease may continuously occur. In this case, if printing is continued, waste paper increases. Hence, in the third modification, if a corner crease is continuously detected, printing is automatically stopped not to increase waste paper.

More specifically, upon continuously detecting a corner crease, the CPU 238 of the inspection apparatus 109 notifies a continuous NG signal to the printing apparatus 107 via the communication cable 254. The CPU 222 of the printing apparatus 107 receives the continuous NG signal using the communication I/F 217. The CPU 222 immediately interrupts printing, and the discharge control unit 247 temporarily discharges sheets in the machine to the escape tray.

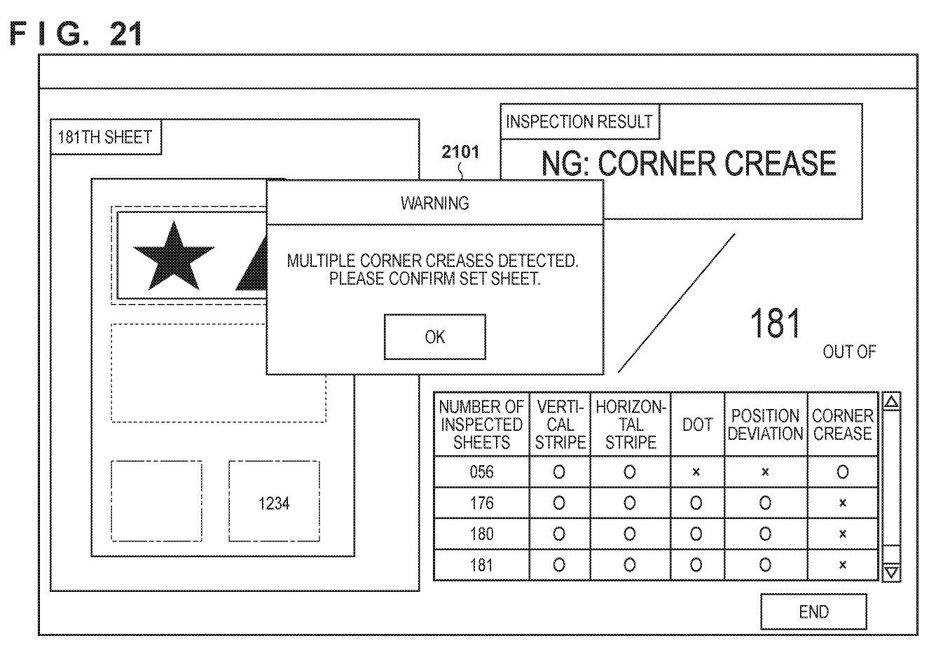

A UI screen that the CPU 238 of the inspection apparatus 109 displays when the corner crease continuously occurs will be described with reference to FIG. 21. Upon detecting that a corner crease occurs a predetermined number of times, the CPU 238 of the inspection apparatus 109 displays a warning 2101 on the UI screen when interrupting printing. The CPU 238 notifies the user of the printing interruption by displaying the warning 2101. The warning 2101 includes a message for prompting the user to confirm the sheet so that the cause of the problem will be eliminated. Note that the warning 2101 is merely an example and may include a change of decurler setting, a fixing condition, a conveyance condition, and the like.

### One Aspect of Function/Effect

According to the image forming system 100 of the third modification, in a case where a corner crease continuously occurs, it is possible to prevent another corner crease from continuously occurring to increase waste paper.

### Fourth Modification

According to the above embodiment, using the correct answer image registered in advance, a corner crease having a predetermined size or more can be determined as inspection NG in accordance with the input of the user. By the way, the print sheet itself included in the scan image used for the correct answer image may have a corner crease. In this case, a portion that is not originally abnormal may erroneously be determined as abnormal in inspection (to be also referred to as overdetection hereinafter). Hence, in the fourth modification, a corner crease is prevented from being included in the correct answer image.

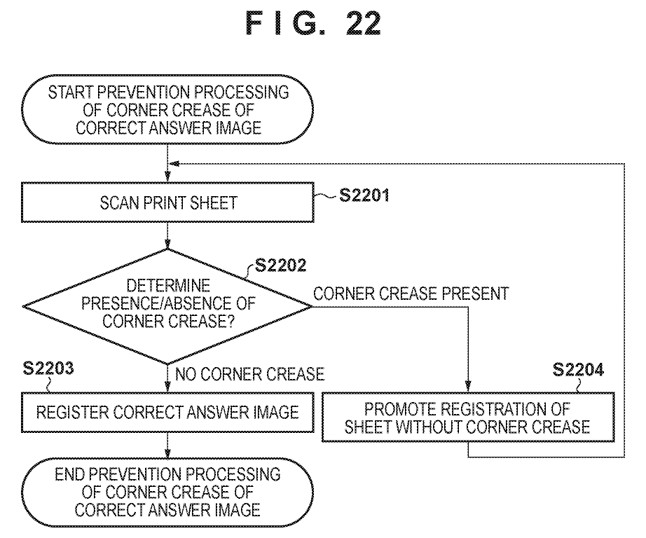

Processing of registering the correct answer image using the scan image will be described with reference to FIG. 22. Note that this processing is implemented by the CPU 238 of the inspection apparatus 109 reading out a program stored in the memory 239 and executing it.

In step S2201, the CPU 238 scans the print sheet (an example of "candidate sheet") using the shooting unit 240. In step S2202, the CPU 238 determines the presence/absence of a corner crease for the scan image. The determination of the presence/absence of a corner crease may be performed by executing the procedure shown in FIG. 7 of the above-described embodiment. If the CPU 238 determines that there is no corner crease, the process advances to step S2203. Otherwise, the process advances to step S2204.

In step S2203, the CPU 238 determines that the scan image is a normal correct answer image, and stores it as a correct answer image in the memory 239. With this processing, the correct answer image is registered. On the other hand, in step S2204, the CPU 238 instructs the shooting unit 240 to scan another print sheet again, and the process returns to step S2201.

One Aspect of Function/Effect

According to the image forming system 100 of the fourth modification, when employing the scan image as the correct answer image, it is possible to prevent a corner crease from being included in the correct answer image.

### her Modifications

Print sheet scan of step S504 may be executed outside the inspection apparatus 109 (for example, by the printing apparatus 107). The inspection apparatus 109 may acquire the scan image of the print sheet from the external apparatus. Also, the method of estimating the vertices of the print sheet is not limited to the method shown in FIG. 8. For example, the print sheet may be approximated to a rectangle, and the vertices of the rectangle may be derived. In addition, the corner crease determination criterion is not limited to the forms shown in FIGS. 17A to 17C.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-199203, filed November 14, 2024, which is hereby incorporated by reference herein in its entirety.

What is claimed is:

1. An inspection apparatus comprising:
one or more memory devices that store a set of instructions; and
one or more processors that execute the set of instructions to:
acquire an image including an inspection target sheet;
set a reference point that is a reference of a corner crease of the inspection target sheet; and
determine presence/absence of the corner crease of the inspection target sheet based on the reference point and an outline of the inspection target sheet in the image.

2. The inspection apparatus according to claim 1, wherein the one or more processors execute instructions in the one or more memory devices to:
acquire the outline of the inspection target sheet;
acquire a first vertex of the inspection target sheet from the outline;
extract an edge point group indicating an edge of the inspection target sheet using the first vertex;
acquire, using the edge point group, a side of the inspection target sheet in a state without a corner crease;
acquire, using the side, a second vertex of the inspection target sheet in a state without a corner crease; and
set the second vertex to the reference point.

3. The inspection apparatus according to claim 2, wherein the one or more processors execute instructions in the one or more memory devices to:
obtain a first point farthest from an origin, a second point farthest from the first point, a third point farthest from a line segment that connects the first point and the second point, and a fourth point farthest from the third point as the first vertex from a point group indicating the outline of the inspection target sheet.

4. The inspection apparatus according to claim 2, wherein the one or more processors execute instructions in the one or more memory devices to:
create a line segment by connecting adjacent first vertices;
extract a fifth point at a first interval along the line segment;
set, at the fifth point, a sixth point at a second interval in a direction orthogonal to the line segment;
extract, at the sixth point, an edge in the image including the inspection target sheet;
select an edge with a highest intensity from extracted edges; and
obtain, as a point forming the edge point group, the sixth point corresponding to an edge having an intensity not less than a first threshold in the edge with the highest intensity.

5. The inspection apparatus according to claim 1, wherein the one or more processors further execute instructions in the one or more memory devices to:
display a setting screen capable of setting a reference value of the corner crease.

6. The inspection apparatus according to claim 5, wherein the one or more processors further execute instructions in the one or more memory devices to:
display a first screen indicating a settable range of the reference value according to a print setting of the inspection target sheet.

7. The inspection apparatus according to claim 5, wherein the one or more processors further execute instructions in the one or more memory devices to:
display a second screen indicating that the corner crease occurs a predetermined number of times on the inspection target sheet.

8. The inspection apparatus according to claim 1, wherein the one or more processors execute instructions in the one or more memory devices to:
determine, using a position of a side, with a corner crease, of the inspection target sheet before occurrence of the corner crease and the outline of the inspection target sheet.

9. The inspection apparatus according to claim 1, wherein the one or more processors execute instructions in the one or more memory devices to:
determine, using a distance between the reference point and the outline of the inspection target sheet, whether the corner crease exists on the inspection target sheet.

10. The inspection apparatus according to claim 1, wherein the one or more processors execute instructions in the one or more memory devices to:
determine, using an area formed by a position of a side, with a corner crease, of the inspection target sheet before occurrence of the corner crease and the outline of the inspection target sheet, whether the corner crease exists on the inspection target sheet.

11. The inspection apparatus according to claim 1, wherein the one or more processors further execute instructions in the one or more memory devices to:
determine presence/absence of an abnormality of the inspection target sheet using a difference between the image including the inspection target sheet and an image including a reference sheet.

12. The inspection apparatus according to claim 11, wherein the one or more processors further execute instructions in the one or more memory devices to:
capture a candidate sheet of the reference sheet;
determine presence/absence of a corner crease on the captured candidate sheet;
set the candidate sheet to the reference sheet upon determining that the candidate sheet has no corner crease; and
instruct to capture another candidate sheet upon determining that the candidate sheet has a corner crease.

13. The inspection apparatus according to claim 11, wherein the one or more processors further execute instructions in the one or more memory devices to:
before determination of the corner crease of the inspection target sheet,
detect a feature point of a pattern formed on the inspection target sheet; and
align the inspection target sheet with the reference sheet using the detected feature point and a feature point of a pattern formed on the reference sheet.

14. A control method of an inspection apparatus, comprising:
acquiring an image including an inspection target sheet;
setting a reference point that is a reference of a corner crease of the inspection target sheet; and
determining presence/absence of the corner crease of the inspection target sheet based on the reference point and an outline of the inspection target sheet in the image.

15. A non-transitory computer-readable storage medium storing a program configured to cause a computer to execute each step of a control method of an inspection apparatus, the control method comprising:
acquiring an image including an inspection target sheet;
setting a reference point that is a reference of a corner crease of the inspection target sheet; and
determining presence/absence of the corner crease of the inspection target sheet based on the reference point and an outline of the inspection target sheet in the image.
